(19) United States
(12) Patent Application Publication
(10) Pub. No.: US 2025/0118169 A1
(43) Pub. Date: Apr. 10, 2025

(54) SYSTEM AND METHOD FOR PLAY OF A SCRATCH-OFF LOTTERY TICKET GAME ACROSS MULTIPLE JURISDICTIONS

(71) Applicant: Scientific Games, LLC, Alpharetta, GA (US)

(72) Inventors: Joseph Waldo Bennett, III, Suwanee, GA (US); Ashley Ivery Gantt, Woodstock, GA (US)

(21) Appl. No.: 18/481,733

(22) Filed: Oct. 5, 2023

(51) Int. Cl. G07F 17/32

(52) U.S. Cl. CPC G07F 17/329

(57) ABSTRACT

A method and system for play of an instant lottery ticket game system by a plurality of jurisdictions includes providing a first set of instant lottery tickets for a primary game to each jurisdiction. A jurisdiction-specific prize structure is provided in the primary game for each jurisdiction. One or more universal prizes are common to all of the jurisdictions. For each of the first sets, an independent number of the instant lottery tickets are designated as universal tickets with a chance to win one of the universal prizes. The universal prizes are randomly assigned to one of the eligible tickets in the pool of the universal-designated tickets. The identity and location of the universal prize winning tickets is kept secret from the jurisdictions and game vendors before and during play of the primary game in the jurisdictions.

### FIELD OF THE INVENTION

The present invention generally relates to a system and method for implementing a scratch-off lottery ticket game, and more particularly to a method wherein lottery tickets eligible to win a universal prize common to all of the jurisdictions are randomly distributed across the multiple jurisdictions.

### BACKGROUND

“Scratch-off” or “instant-win” lottery tickets have enjoyed immense popularity in the lottery industry for decades. These games offer distinct advantages to the lottery authorities and are attractive to a broad spectrum of players.

The scratch-off lottery ticket games typically have a multi-tiered prize structure with relatively few prizes at the top tier level. The number of predetermined winning tickets in each tier increases as the prize tiers are further removed from the top prize tier level. The top prizes can be quite attractive to potential players and are often advertised extensively to draw players to the game.

Particularly in Europe and the U.S., multi-jurisdictional games exist wherein a common scratch-off lottery ticket game is played across multiple jurisdictions, such as separate countries in Europe or separate states in the U.S. These games have a common prize structure wherein the number and value of prizes (including the top tier prizes) are predetermined based on the payout of the game and the total number of tickets allocated to the game. For example, a game having five million tickets provided throughout the jurisdictions may have five top tier prizes (and a number of lesser tier prizes), whereas a game having twenty million tickets provided throughout the jurisdictions with the same payout percentage may have twenty top tier prizes (and a number of lesser tier prizes). All of the prizes (including the top tier prizes) are randomly distributed throughout the jurisdictions. Thus, it is possible that one or more of the jurisdictions may not receive a top tier prize ticket, or even that a single jurisdiction may receive all of the top tier prize tickets.

With the conventional practice, each jurisdiction is provided with a validation file for the lottery tickets provided to the jurisdiction, the validation file containing a record of each winning lottery ticket within the jurisdiction. Thus, the jurisdiction is aware of the number of top tier prize tickets that can possibly be won by patrons within the jurisdiction. This situation creates a dilemma for the jurisdictions. Specifically, a jurisdiction may offer lottery tickets to its citizens advertising the chance to win a top tier prize (e.g., “Win a top prize of $1 Million!”) yet be aware (from the validation file) that no top tier prize tickets are even available for sale in the jurisdiction. Even if one or more top tier prize tickets were initially available and known to the jurisdiction, the same dilemma exists when the jurisdiction becomes aware that these winning tickets have been redeemed and no more top tier prize tickets exist in the jurisdiction but may still be available in other jurisdictions.

Certain lottery jurisdictions around the world (particularly in the U.S. and Europe) have adopted the practice of publicizing to patrons on a periodic basis (e.g., daily or weekly) the number of prizes remaining in each tier of the prize structure for individual scratch-off lottery ticket games. For various reasons (which may include consideration of the dilemma discussed above), these jurisdictions will also terminate the game when all of the top tier prizes have been awarded. For example, if a particular game has three top prizes worth $500,000 each, the game will end when the last of the three $500,000 prizes has been awarded. The unsold scratch-off lottery tickets remaining in the game are pulled from the point-of-sale locations and are typically destroyed.

The above-described practice is, however, disadvantageous in certain respects. Scratch-off lottery ticket games have a design payout based on play of a percentage of the complete run of lottery tickets in the game (the total number of tickets printed and made available for sale and play of the game). For example, a particular game may have a ticket run of ten million tickets with a designed payout of 50%, meaning that half of the money generated by ticket sales is paid out as prizes and the other half of the money constitutes lottery revenue for the jurisdiction. If a game is prematurely ended after the top prizes have been awarded, the payout percentage can be significantly increased to the detriment of the jurisdiction. For example, the game mentioned above having a ticket run of ten million tickets may be terminated after the sale of only two million of the tickets because the three top prizes were awarded. The lottery jurisdiction then loses the revenue from the sale of up to eight million additional tickets. The payout percentage at the early termination of the game may be, for example, 70% of the proceeds generated by sale of the two million tickets, which is significantly greater than the 50% designed payout.

U.S. Pat. No. 7,153,206 proposes an instant lottery ticket game structure includes a ticket validation file containing prize codes for at least some of the lottery tickets (i.e., at least the winning tickets). Provision is made for certain of the instant lottery tickets to have a variable redemption value by allowing the prize codes in the validation file to be changed under certain predetermined circumstances. These tickets, whether printed or electronically simulated, are provided with play indicia under a removable coating that indicates that the redemption value of that lottery ticket is variable. Using the host computer, a lottery administration can change the prize codes and therefore the redemption value of these instant lottery tickets according to the predetermined criteria such as the termination of a game. In some cases, a player can have the option to redeem an instant lottery ticket for a first value or wait until after termination of the game where a possibly higher redemption value might be assigned to that ticket due to the host computer randomly selecting that ticket to change its prize code to a greater value.

The industry, lottery jurisdictions, and public in general would benefit from additional improved methods and game systems to alleviate the dilemma and consequences discussed above that are faced by jurisdictions in a multi-jurisdictional game.

### SUMMARY

Objects and advantages of the invention will be set forth in part in the following description, or may be obvious from the description, or may be learned through practice of the invention.

In accordance with aspects of the invention, a method is provided for implementing an instant lottery ticket game system played by a plurality of jurisdictions. The jurisdictions may be, for example, a state, region, or other municipality that has authorized the play of lottery games within its borders or boundaries. For example, in the United States, each state may be considered as a separate jurisdiction. In Europe, each country may be considered as a separate jurisdiction, or regions within a country may be considered as separate jurisdictions. The lottery game systems are generally provided to the jurisdictions by a third-party game provider that may also administer certain administrative and accounting aspects of the games.

The method includes designating a first set of instant lottery tickets in a primary game for each of the jurisdictions, wherein the instant lottery tickets may be scratch-off lottery tickets. A jurisdiction-specific prize structure is assigned to each of the first sets such that each jurisdiction has an independent prize structure for the primary game. These prize structures may be established by the individual jurisdictions and may be different between the respective jurisdictions. The method includes establishing a universal prize structure that is common to the first sets across all of the jurisdictions, the universal prize structure including at least one universal top prize. The universal prize structure is “common” to the jurisdictions in that the universal prizes are randomly distributed throughout the jurisdictions, with no one jurisdiction having the knowledge or awareness of where any particular universal prize will be awarded.

The method may include providing indicia on each of the instant lottery tickets in all of the first sets that identifies the possibility that such ticket may win the universal top prize (or other universal prizes).

The first sets of instant lottery tickets (with universal prize indicia thereon) are eventually printed and delivered to the respective jurisdictions.

The method includes, for each of the first sets, designating an independent number of the instant lottery tickets as universal tickets having a chance to win the universal top prize (or other universal prizes). For example, a particular jurisdiction may request three million instant lottery tickets in its respective first set. A defined number (e.g., three thousand) of these tickets may also be earmarked as universal tickets that have a chance of winning the universal top prize (or other universal prizes).

The total number of universal tickets to be divided and distributed to the jurisdictions may be variously determined. For example, this total number of the universal tickets may be dependent upon the total number of instant lottery tickets provided for the primary game in all of the jurisdictions, a total number of the universal top prizes and any other universal prizes, a minimum or maximum desired number of universal tickets for each jurisdiction, and so forth.

The total number of universal tickets for all of the first sets form a collective pool. A random generation event or process then assigns the universal top prize(s) to one of the universal tickets in the pool. This random assignment may occur before or after the universal tickets are assigned to the various jurisdictions. For example, the pool of universal tickets may include ten thousand tickets. The universal top prize(s) (and other universal prizes that may be present in the game) may be randomly assigned to one of these ten thousand universal tickets, wherein the entire pool is then randomly distributed or seeded into the first set of instant lottery tickets provided to the jurisdictions.

Alternatively, the pool can be randomly distributed to the jurisdictions before each of the universal prizes are randomly assigned to one of the universal tickets.

It is also possible that the universal prizes are randomly assigned within the remaining pool of universal tickets each time a player enters their ticket into a system for possible redemption. For example, a player may be instructed to scan or enter a code on their instant lottery ticket at a website to determine if the ticket has won one of the universal prizes. If such ticket is an actual universal-designated ticket, and one or more of the universal prizes remains, the control system may conduct a random generation event with all of the remaining universal tickets in the pool. If the player's ticket is selected in this random generation event, then the player is informed that the ticket can be redeemed for the particular universal prize.

The method includes maintaining the identity and location of the universal/instant lottery tickets having a universal prize assigned thereto secret from the jurisdictions before play of the primary game commences in the jurisdictions until the universal top prize is awarded in one of the jurisdictions. Thus, at the start of the primary game in the jurisdictions up until all of the universal top prizes have been awarded throughout the jurisdictions, no individual jurisdiction possesses the knowledge of where the universal top prize (or any remaining universal top prizes) will be awarded.

As mentioned, the universal prize structure may include a plurality of the universal top prizes that are each randomly assigned to a respective one of the universal tickets in the pool as discussed above.

In still another embodiment, the universal prize structure may include a plurality of universal lower tier prizes that are each randomly assigned to a respective one of the universal tickets in the pool as discussed above. In a certain embodiment, each universal ticket in the pool has one of the plurality of universal top prizes or one of the plurality of universal lower tier prizes assigned thereto. In other words, every universal ticket has a universal prize assigned thereto. In another embodiment, less than all of the universal tickets in the pool has one of the universal top prizes or one of the universal lower tier prizes assigned thereto.

The number of universal tickets designated for each of the first sets (i.e., for each jurisdiction) may be variously determined. For example, this number may be based on the number of instant lottery tickets provided to each of the jurisdictions in the primary game. A jurisdiction that orders five million tickets in the primary game may receive more universal tickets than a jurisdiction that orders one million tickets in the primary game.

In an alternate embodiment, the number of universal tickets for each jurisdiction may be determined randomly from the pool of universal tickets. In this embodiment, it is possible that the jurisdiction ordering the most tickets in the primary game receives the least (or none) of the universal tickets.

Embodiments of the present method may include generating a validation file for each jurisdiction that contains a record for each of the instant lottery tickets in the first set that wins a prize in the jurisdiction-specific prize structure. For various reasons, validation file may include a record of the non-winning tickets in the primary game as well. The respective validation files are void of a record or information that identifies location of the universal ticket(s) having the universal top prize(s) or lesser tier universal prizes assigned thereto. This embodiment may include generating a confirmation file that contains a record of the universal tickets having a universal top prize assigned thereto, wherein this confirmation file is maintained by a lottery provider or third party and used in a reveal or validation process separate from the validation process managed by the jurisdiction for the jurisdiction-specific prize structure.

The present invention also encompasses a scratch-off lottery ticket game system for play in a plurality of jurisdictions, as discussed above. The system includes a first set of scratch-off lottery tickets for a primary game in each of the jurisdictions. A jurisdiction-specific prize structure is assigned to each of the first sets such that each jurisdiction has an independent prize structure for the primary game that may be the same as or different from the prize structures in other jurisdictions. The game system includes a universal prize structure that is common to the first sets across all of the jurisdictions, the universal prize structure including at least one universal top prize. Indicia is provided on each of the scratch-off lottery tickets in all of the first sets that identifies a chance to win the universal top prize. For each of the first sets, an independent number of the scratch-off lottery tickets are designated as universal tickets having a chance to win the universal top prize. The universal top prize is randomly assigned to one of the universal tickets in a pool of all of the universal tickets from all of the first sets, whereby the identity and location of the universal ticket having the universal top prize assigned thereto is maintained secret from the jurisdictions and game vendors before play of the primary game commences in the jurisdictions until the universal top prize is awarded in one of the jurisdictions.

The various aspects of the method embodiments discussed above may be incorporated into various embodiments of the game system.

The instant lottery tickets in the game system may be paper or electronic scratch-off lottery tickets having game play indicia under a real or virtual removable scratch-off coating.

### BRIEF DESCRIPTION OF THE DRAWINGS

A full and enabling disclosure including the best mode of practicing the appended claims and directed to one of ordinary skill in the art is set forth more particularly in the remainder of the specification. The specification refers to the appended figures, in which:

FIG. 1 is a diagram of primary instant ticket lottery game system provided by a game provider to a plurality of jurisdictions;

FIG. 2 is a table representing a fixed multi-tiered prize structure for lesser prizes in a primary scratch-off lottery ticket game that may be embodied in the system of FIG. 1 according to aspects of the present invention;

FIGS. 3A and 3B depict examples of scratch-off lottery tickets in accordance with aspects of the invention;

FIG. 4 depicts a system and method for playing a primary lottery ticket game across multiple jurisdictions in accordance with aspects of the invention; and

FIG. 5 is a table representing a universal prize structure.

### DETAILED DESCRIPTION

Reference will now be made in detail to various and alternative exemplary embodiments and to the accompanying drawings, with like numerals representing substantially identical structural elements. Each example is provided by way of explanation, and not as a limitation. In fact, it will be apparent to those skilled in the art that modifications and variations can be made without departing from the scope or spirit of the disclosure and claims. For instance, features illustrated or described as part of one embodiment may be used on another embodiment to yield a still further embodiment. Thus, it is intended that the present disclosure includes modifications and variations as come within the scope of the appended claims and their equivalents.

Generally, the present disclosure is directed to an instant lottery ticket game system 10 and method 100 that facilitate play of a primary scratch-off lottery ticket game across multiple jurisdictions, wherein each jurisdiction has an independent jurisdiction-specific prize structure 24 (FIG. 2) for the primary game. These prize structures may be established by the individual jurisdictions and may be different between the respective jurisdictions. The system 10 and method 100 include establishing a universal prize structure 25 (FIG. 5) that is common to the first sets across all of the jurisdictions, the universal prize structure including at least one universal top prize. As mentioned, the universal prize structure is common to all of the jurisdictions in that such prizes are randomly awarded throughout the jurisdictions and on one jurisdiction or the game vendors (e.g., retail establishments where tickets are sold) has the knowledge or awareness of where any particular universal prize will be awarded.

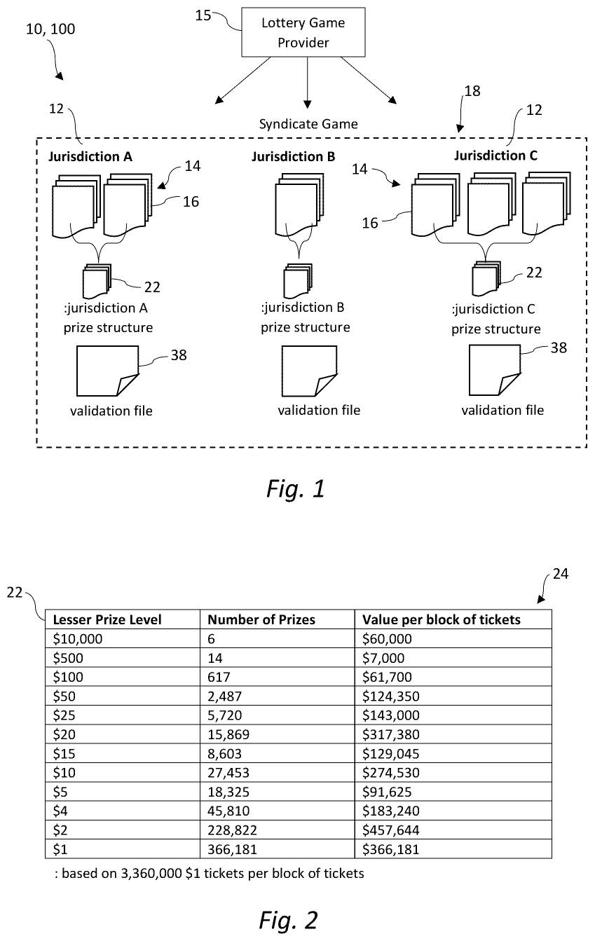

Referring to FIG. 1, aspects of a primary lottery ticket 18 game implemented in a plurality of different jurisdictions 12 are depicted, wherein each jurisdiction may be, for example, a state, region, or other municipality that has authorized the play of lottery games within its borders. The lottery games are generally provided to the jurisdictions 12 by a third-party game provider 15 that may also administer certain administrative and accounting aspects of the games. An example of a game provider is Scientific Games having its global headquarters in Alpharetta, Georgia, USA.

The present method and system include designating a first set 14 of instant lottery tickets 16 for a primary game 18 to be printed for each of the jurisdictions 12, which may be paper or electronic scratch-off lottery tickets. These first sets 14 of instant lottery tickets may share a game theme, such as a sports or holiday theme, and art typically provided to the jurisdictions 12 in “blocks” having a fixed number of tickets. In accordance with the present disclosure, each of the first sets 14 has a fixed, multi-tiered and jurisdiction-specific prize structure (FIG. 2) for prizes 22 in the primary game. For example, FIG. 2 depicts a block of the lottery tickets 16 for one of the first sets 14 in the primary game 18 that has 3,360,000 tickets and the multi-tiered prize structure 24. As an example, FIG. 1 depicts that Jurisdiction A is provided with a first set 14 of the lottery tickets 16 in the primary game comprised of two blocks of tickets 16 each having the specific prize structure 24 depicted in FIG. 2. Similarly, the first set 14 of the lottery tickets 16 in the primary game provided to Jurisdiction B comprises a single block of the lottery tickets 16 having a prize structure 24 that may be the same as or different from the particular prize structure 24 depicted in FIG. 2. The first set 14 of the lottery tickets 16 in the primary game provided to Jurisdiction C comprises three blocks of the tickets 16 each having a prize structure 24 specific to jurisdiction C that may be the same as or different from the particular prize structure depicted in FIG. 2.

The respective jurisdictions A-C may determine the prize structure 24 for the primary game 18 completely independent from the other jurisdictions. Thus, the number of prizes 22 and monetary value of these prizes 22 may vary from one jurisdiction to another.

Stiff referring to FIG. 1 the method 10 and associate system 100 may include generating a validation file 38 for each jurisdiction A-C that contains a record of each of the instant lottery tickets 16 in the first set that wins one of the prizes 22 within the prize structure 24 assigned to the first set 14. The generation and use of electronic validation files 38 in the industry is well-known. These files 38 contain an electronic record of each winning ticket (and may include a record for the non-winning tickets) and are used to validate a ticket presented by a player for redemption of a prize. Each ticket 16 generally includes a code that links to its respective record in the validation file 38. The validation files 38 are also used for accountability purposes between the lottery game provider and the jurisdiction, and for various other reasons. For the present method 10, these jurisdiction-specific validation files 38 are provided to each jurisdiction A-C and are void of a record or information that identifies location where the universal top prize(s) or other universal prizes will be awarded, as discussed in greater detail below.

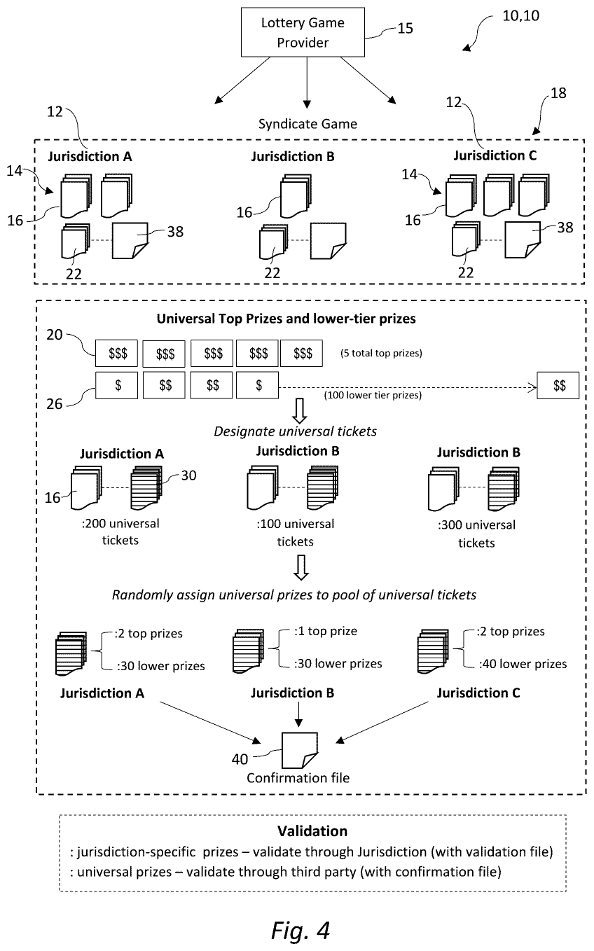

Referring to FIG. 4, the method 10 and associated system 100 include designating an independent number of the instant lottery tickets 16 to be printed (real or virtual) for each jurisdiction as universal tickets 30 that have a chance to win the universal top prize 20 (or one of multiple universal top prizes 20 or universal lower-tier prizes 26). The number of universal tickets 30 within each of the first sets 14 may be variously determined. For example, the number of universal tickets 30 may be based on the number of the instant lottery tickets 16 provided to each of the jurisdictions A-C in the primary game 18 such that a jurisdiction that purchases a greater number of tickets 16 in the primary game 18 receives a greater number of the universal-designated tickets 30 in its respective first set 14. Alternatively, the number of universal tickets 30 within each of the first sets 14 may be randomly determined such that no jurisdiction is guaranteed a certain number of universal tickets 30, or is only guaranteed a minimum number of the universal tickets 30. The total number of universal tickets 30 in their first set 14 may not be made known to the jurisdiction A-C.

In an alternate embodiment, the number of universal tickets 30 for each jurisdiction may be determined randomly from the pool of universal tickets 30. In this embodiment, it is possible that the jurisdiction ordering the most tickets 16 in the primary game receives the least (or none) of the universal tickets 30.

Once the number of universal-designated tickets 16, 30 is determined for each jurisdiction A-C, the designation of such tickets within each set 14 can be randomly determined.

As mentioned, the universal top prize(s) 20 are common to all jurisdictions, and the players in the various jurisdictions A-C have a chance to win the common top prize(s) 20. The number of universal top prizes 20 can vary. For example, FIG. 4 depicts that there are five universal top prizes 20 that are common across all of the jurisdictions A-C. In addition, the universal prize structure may include a plurality of universal lower-tier prizes 26.

Still referring to FIG. 4, the total number of universal tickets 30 for all of the first sets 14 form a collective pool. A random generation event or process assigns each of the universal prizes 20, 26 to a respective one of the universal tickets 30 in the pool. This random assignment may occur before or after the universal tickets 30 are split up and assigned to the various jurisdictions. For example, the pool of universal tickets 30 in the embodiment of FIG. 4 includes six hundred tickets (without reference to where these tickets 300 are distributed). The universal top prizes 20 and lower tier prizes 26 may each be randomly assigned to one of these six hundred universal tickets 30, wherein the entire pool is then randomly distributed or seeded into the first set 14 of instant lottery tickets 16 provided to each of the jurisdictions A-C. For example, in FIG. 4, after the random assignment of the universal top prizes 20 and universal lower tier prizes 26 to the pool of universal tickets, the pool is randomly distributed to the jurisdictions A-C. Alternatively, the pool can be randomly distributed to the jurisdictions A-C before the universal prizes 20, 26 are randomly assigned to respective ones of the universal tickets 30.

The total number of universal tickets 30 in the pool may be variously determined. For example, this total number of the universal tickets 30 may be dependent upon the total number of instant lottery tickets 16 provided for the primary game 18 in all of the jurisdictions A-C, a total number of the universal top prizes 20 and any other universal prizes 26, a minimum or maximum desired number of universal tickets 30 for each jurisdiction, and so forth.

It is also possible that the universal prizes 20,26 are randomly assigned within the remaining pool of universal tickets 30 each time a player enters their ticket 16 into a system for possible redemption. For example, a player may be instructed to scan or enter a code on their instant lottery ticket 16 at a website to determine if the ticket 16 has won one of the universal prizes 20, 26. If such ticket is an actual universal ticket 30, and one or more of the universal prizes 20, 26 remains, the control system may conduct a random generation event with all of the remaining universal tickets 30 in the pool. If the player's ticket 16, 30 is selected in the random generation event, then the player is informed that the ticket 16, 30 can be redeemed for a particular universal prize.

The method includes maintaining the identity and location of the universal-designated instant lottery tickets 16 having the universal top prizes 20 and other universal prizes 26 assigned thereto secret from the jurisdictions A-C before play of the primary game 18 commences in the jurisdictions. Thus, at the start of the primary game 18 in the jurisdictions up until all of the universal prizes 20, 26 have been awarded throughout the jurisdictions, no individual jurisdiction possesses the knowledge of where the universal prizes 20, 26 (or any remaining universal prizes 20, 26) will be awarded.

In a certain embodiment, each universal ticket 30 in the pool may have one of the universal prizes 20, 26 assigned thereto. In other words, every universal-designated ticket 16, 30 is a winning ticket with a universal prize 20, 26 assigned thereto. In another embodiment, less than all of the universal tickets 30 in the pool has one of the universal prizes 20, 26 assigned thereto.

As depicted in FIG. 4, the method 10 and system 100 may include generating a confirmation file 40 that contains information to validate the universal-designated tickets 16, 30 having a universal prize assigned thereto. This confirmation file 40 is not a part or a component of the validation files 38 supplied by the lottery provider 15 to the jurisdictions A-C, but is maintained by the lottery provider 15 or another third party and used in a validation process of the universal tickets 30 that is separate from the jurisdiction's validation process for the instant lottery tickets 16 in the primary game. The jurisdictions A-C do not have access to the confirmation file 40 and, thus, cannot ascertain the identity or location of the universal-designated tickets 16, 30 having a universal prize 20, 26 assigned thereto.

The algorithms and control systems used for designing scratch-off lottery ticket games are well-known to lottery ticket providers. These systems and their highly secure control processors can be programmed to perform the steps discussed above, including determining the correct number of universal-designated tickets 30 for each jurisdiction, performing the random and secret assignment of the universal prizes to the tickets 30, randomly seeding the universal tickets 30 throughout the jurisdictions, creating the validation and confirmation files, and so forth.

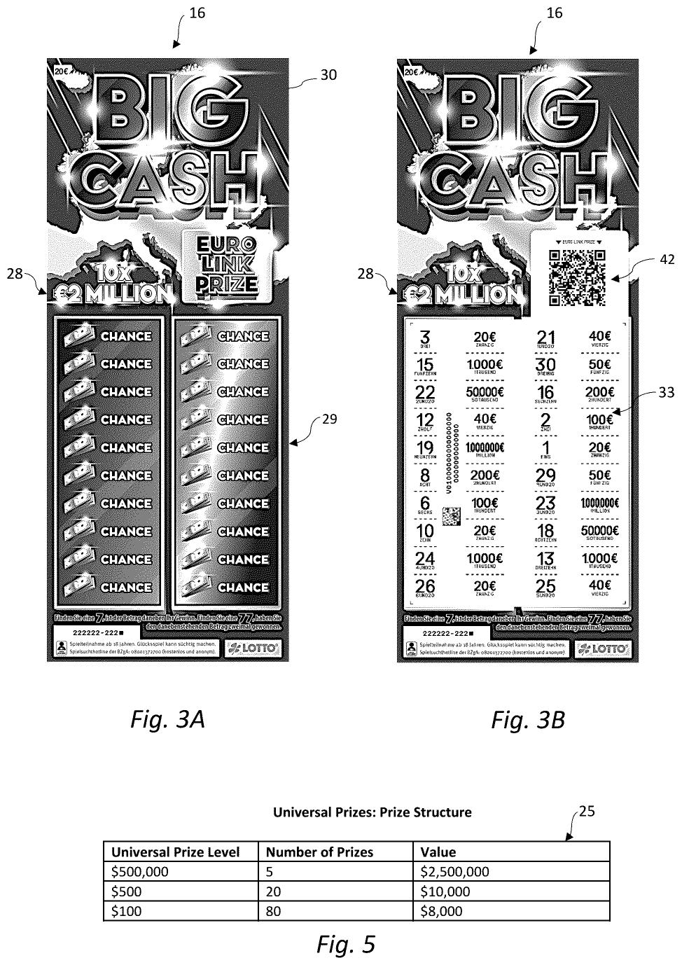

Referring to FIGS. 3A-3B, various depictions of an example of the instant lottery ticket 16 are provided. FIG. 3A depicts a ticket 16 in the primary game that is presented to a player. A plurality of these tickets 16 make up the first set of tickets 14 provided to a jurisdiction. The ticket 16 includes indicia 29 related to play of the primary game 18 for the prizes contained in the jurisdiction-specific prize structure 24. This indicia may be printed on a scratch-off coating (SOC) layer that overlies the game-play symbols 33. Indicia 28 is also provided on all of the tickets 16 in the primary game 18 that advertises the chance to win a universal prize (e.g., a 2 million euro prize). In this instance, the indicia references the universal top prize. The ticket 16 in FIG. 3A may or may not have been designated as a universal ticket 30 in the pool of universal tickets 30 discussed above. The status of the ticket as a “universal ticket” is not provided on the face of the un-played ticket 16.

It should be appreciated that designation of the initial universal tickets 30 is a means to define a pool of simulated tickets from which the universal prizes would be randomly drawn/assigned. Each “entry” in the pool is simply represented as a universal-designated ticket 30 from one of the first sets. Once the universal prizes have been randomly assigned to the universal tickets 30 that are randomly seeded throughout the first sets, the pool of universal tickets is not needed.

FIG. 3B depicts the ticket of FIG. 3A after removal of the SOC. a top prize winning ticket 32 (e.g., wins the 2 million euro prize). The ticket 16 has indicia 42 under a section of the scratch-off coating that instructs the player on how to determine if the ticket wins a universal prize (i.e., one of the universal top prizes or lesser tier prizes). In this instance, the indicia is a code, and the player is instructed to scan and enter the code at a website to determine the status of the ticket. This process is completely separate from the validation process used to validate winning tickets under the jurisdiction-specific prize structure in the primary game. The ticket 16 in FIG. 3B may or may not be a winning ticket (determined by the game play symbols 33. The code 42 will link the ticket to the confirmation file 40 maintained separate from the validation file 38, as discussed above. If the ticket 16 is validated as a winner of a universal prize, the player may be instructed to redeem the winning ticket at a lottery office in the jurisdiction in which the ticket was purchased, wherein the lottery provider or third party sends a confirmation notice to the lottery jurisdiction in order for the ticket to be redeemed. In an alternate embodiment, the redemption system managed by the lottery provider or other third-party provider could pay the redemption amount directly into a digital wallet established for the player.

Those skilled in the art appreciate that the present methods and systems may be implemented by conventional technology that may include servers, computers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A method for implementing an instant lottery ticket game system played by a plurality of jurisdictions, comprising:
designating a first set of instant lottery tickets in a primary game for each of the jurisdictions;
assigning jurisdiction-specific prize structure to each of the first sets such that each jurisdiction has an independent prize structure for the primary game;
assigning a universal prize structure that is common to the first sets across all of the jurisdictions, the universal prize structure including at least one universal top prize;
providing indicia on each of the instant lottery tickets in all of the first sets that identifies a chance to win the universal top prize;
producing the first sets of instant lottery tickets with the indicia thereon;
for each of the first sets, designating an independent number of the instant lottery tickets as universal tickets having a chance to win the universal top prize;
at a time of the designation of the universal tickets or afterwards, from a pool representing the universal tickets from all of the first sets, randomly assigning the universal top prize to one of the universal tickets; and
maintaining identity and location of the universal ticket having the universal top prize assigned thereto secret from the jurisdictions before play of the primary game commences in the jurisdictions.

2. The method of claim 1, wherein the universal prize structure includes a plurality of the universal top prizes that are each randomly assigned to a respective one of the universal tickets in the pool.

3. The method of claim 2, wherein the universal prize structure includes a plurality of universal lower tier prizes that are each randomly assigned to a respective one of the universal tickets in the pool.

4. The method of claim 3, wherein each of the universal tickets in the pool has one of the plurality of universal top prizes or one of the plurality of universal lower tier prizes assigned thereto.

5. The method of claim 3, wherein less than all of the universal tickets in the pool has one of the plurality of universal top prizes or one of the plurality of universal lower tier prizes assigned thereto.

6. The method of claim 1, wherein the number of universal tickets designated for each of the first sets is determined based on a number of the instant lottery tickets provided to each of the jurisdictions in the primary game.

7. The method of claim 1, wherein the number of universal tickets designated for each of the first sets is randomly determined.

8. The method of claim 1, wherein the random assignment of the universal top prize to one of the universal tickets in the pool is done prior to commencement of the primary game in the jurisdictions.

9. The method of claim 1, wherein the random assignment of the universal top prize to one of the universal tickets in the pool is done after commencement of the primary game in the jurisdictions.

10. The method of claim 1, further comprising generating a validation file for each jurisdiction that contains a record for each of the instant lottery tickets in the first set winning a prize in the jurisdiction-specific prize structure, the respective validation file provided to each jurisdiction and being void of a record or information that identifies location of the universal ticket having the universal top prize assigned thereto.

11. The method of claim 10, further comprising generating a confirmation file that contains a record of the universal ticket having the universal top prize assigned thereto, the confirmation file maintained by a lottery provider or third party, wherein each of the instant lottery tickets in the primary game includes instructions to a player on how to determine whether the respective instant lottery ticket wins the universal top prize via the lottery provider or third party separate from a validation process maintained by the jurisdiction for the jurisdiction-specific prize structure.

12. The method of claim 11, wherein a plurality of the universal tickets in the pool has one of a plurality of the universal top prizes or one of a plurality of universal lower tier prizes assigned thereto, the confirmation file containing a record of each of the universal tickets having a universal top prize or universal lower tier prize assigned thereto.

13. The method of claim 1, wherein the instant lottery tickets are scratch-off lottery tickets.

14. A scratch-off lottery ticket game system for play in a plurality of jurisdictions, comprising:
a first set of scratch-off lottery tickets for a primary game for each of the jurisdictions;
a jurisdiction-specific prize structure assigned to each of the first sets such that each jurisdiction has an independent prize structure for the primary game;
a universal prize structure that is common to the first sets across all of the jurisdictions, the universal prize structure comprising at least one universal top prize;
indicia on each of the scratch-off lottery tickets in all of the first sets that identifies a chance to win the universal top prize;
wherein for each of the first sets, an independent number of the scratch-off lottery tickets having been designated as universal tickets having a chance to win the universal top prize;
wherein from a pool representing the universal tickets from all of the first sets, the universal top prize being randomly assigned to one of the universal tickets; and
wherein identity and location of the universal ticket having the universal top prize assigned thereto is maintained secret from the jurisdictions before play of the primary game commences in the jurisdictions until the universal top prize is awarded in one of the jurisdictions.

15. The game system of claim 14, wherein the universal prize structure comprises a plurality of the universal top prizes that are each randomly assigned to a respective one of the universal tickets in the pool, and a plurality of universal lower tier prizes that are each randomly assigned to a respective one of the universal tickets in the pool.

16. The game system of claim 15, wherein each of the universal tickets in the pool has one of the plurality of universal top prizes or one of the plurality of universal lower tier prizes assigned thereto.

17. The game system of claim 14, wherein the number of universal tickets in the pool designated for each of the first sets is determined randomly or based on a number of the scratch-off lottery tickets provided to each of the jurisdictions in the primary game.

18. The game system of claim 14, further comprising a validation file for each jurisdiction that contains a record for each of the scratch-off lottery tickets in the first set that wins a prize in the jurisdiction-specific prize structure, the validation files being void of a record or information that identifies location of the universal ticket having the universal top prize assigned thereto.

19. The game system of claim 18, further comprising a confirmation file that contains a record of the universal ticket having the universal top prize assigned thereto, the confirmation file maintained by a lottery provider or third party, wherein each of the scratch-off lottery tickets in the primary game comprises instructions to a player on how to determine whether the respective instant lottery ticket wins the universal top prize via the lottery provider or third party separate from a validation process maintained by the jurisdiction for the jurisdiction-specific prize structure.

20. The game system of claim 19, wherein a plurality of the universal tickets in the pool has one of a plurality of the universal top prizes or one of a plurality of universal lower tier prizes assigned thereto, the confirmation file containing a record of each of the universal tickets having a universal top prize or universal lower tier prize assigned thereto.
